(19) United States
(12) Patent Application Publication
(10) Pub. No.: US 2026/0145362 A1
(43) Pub. Date: May 28, 2026

(54) METHOD AND DEVICE FOR PRODUCING A COMPOSITE BODY

(71) Applicant: Baustoffwerke Gebhart & Soehne GmbH & Co. KG, Lachen (DE)

(72) Inventors: Hans GEBHART, Lachen (DE); Gordian GEBHART, Lachen (DE); Franz PFEIFFER, Lachen (DE)

(21) Appl. No.: 19/121,457

(22) PCT Filed: Oct. 16, 2023
(86) PCT No.: PCT/EP2023/078713

§ 371 Date: Apr. 16, 2025

(30) Foreign Application Priority Data
Oct. 18, 2022 (DE) 10 2022 127 331.8

(51) Int. Cl. B28B 23/00; B28B 11/08; B32B 7/12; B32B 13/04

(52) U.S. Cl. CPC B28B 23/0062; B28B 11/0818; B28B 23/0018; B32B 7/12; B32B 13/04; B32B 2250/02; B32B 2419/04

(57) ABSTRACT

The invention relates to a method for producing a composite body (1) comprising a concrete body (2) and a flat element (3). An underside (3a) of the flat element (3) is adhered to an upper side (2b) of the concrete body (2). An upper side (3b) of the flat element (3) forms an upper side of the composite body (1). An adhesive (4) is applied to at least one sub-region of the underside (3a) of the flat element (3). The flat element (3) is then moved towards the concrete body (2) and pressed onto the upper side (2b) of the concrete body (2) from above. The pressing of the flat element (3) onto the concrete body (2) is carried out in a green phase of the concrete body (2), in which the concrete body (2) is dimensionally stable but not yet bonded.

The present application claims the priority of German patent application no. 10 2022 127 331.8, the content of which is fully incorporated herein by reference.

The invention relates to a method for producing a composite body which comprises a concrete body and a planar element, whereby a lower side of the planar element is adhesively bonded to an upper side of the concrete body, and wherein an upper side of the planar element forms an upper side of the composite body.

The invention furthermore relates to a device for producing a composite body which comprises a concrete body and a planar element, wherein a lower side of the planar element is adhesively bonded to an upper side of the concrete body, and an upper side of the planar element forms an upper side of the composite body.

The invention also relates to a composite body as claimed in claim 26.

Natural stone slabs, tiles and ceramic slabs, etc., are known in the general prior art for laying flooring, especially outdoors. It has been demonstrated that particularly tiles and ceramic slabs, especially with higher material thicknesses, meet technical and economic limits, especially in a so-called loose construction mode.

For efficient technical and economic production, it has proven to be advantageous when the tile or the ceramic slab is used in conjunction with a concrete body.

A generic method and a device for producing a composite body which has a concrete body and a planar element is known from EP 3 216 776 B1 .

In the generic document it is proposed that an adhesive is applied to a lower side of a solid brick body, or of a ceramic slab, in order to adhesively bond the ceramic slab to a concrete body. For this purpose, the ceramic slab is placed in a casting mold, which is used for manufacturing or producing the concrete body. The ceramic slab should seal conjointly with the side walls of the casting mold. The ceramic slab is placed in the casting mold in such a manner that the upper side of the ceramic slab, which later forms the upper side of the composite body, is oriented downward. The lower side of the ceramic slab on which the adhesive is applied is thus oriented upward. After the ceramic slab is disposed accordingly in the mold, a concrete material is filled into the casting mold. It is proposed to fill the mold in such a manner that a concrete layer with a thickness of 1 to 12 cm, preferably 3 to 8 cm, results. After filling with the concrete material, a compaction, preferably in conjunction with vibration, can take place in a generally known manner. Once the filled concrete material has at least partially cured, in particular to the extent that the concrete body formed by the concrete material is green-stable or has a green-stable state in which the concrete body is dimensionally stable but not yet cured, the composite body formed from the concrete body and the ceramic slab can be removed from the mold and preferably moved into a curing chamber in which a higher temperature prevails. The concrete body can completely harden in the curing chamber.

In EP 3 216 776 B1 , as an alternative to filling the mold with a pourable concrete material, it is also proposed that a cured concrete body is fed to the ceramic slab placed in the casting mold and provided with an adhesive, and said concrete body is placed on the lower side of the ceramic slab. The cured concrete body herein should exhibit a concrete with a so-called “open structure”. In the generic document it is stated that a concrete with an open structure is suitable for connecting to the adhesive applied to the ceramic slab, since the adhesive can penetrate into the pores of the concrete body. In the generic document, the addition of polymerizable monomers is proposed in order to achieve the penetration of the adhesive into the pores of the concrete body. For this purpose, it is provided that the adhesive applied to the ceramic slab is coated accordingly before the concrete body is placed on the ceramic slab. As a further alternative embodiment, it is proposed that, instead of a cured concrete body on the ceramic slab provided with the polymerizable monomers, a concrete mass is filled onto the coated surface of the ceramic slab.

In terms of the further prior art, reference is also made to EP 3 216 775 B1 which proposes that for adhesively bonding a tile to a concrete body, a primer composition containing monomers forming part of a water-polymerizable polymerization system is used, wherein the primer composition is applied to a surface of the tile and to a surface of the concrete body.

In terms of the further prior art, reference is furthermore also made to EP 3 231 784 A1.

In the generic device and the generic method it is disadvantageous that the ceramic slab must be inserted exactly into the casting mold for the concrete body, so that the pourable concrete material can then be applied, or a concrete body with an open structure can be pressed onto the correspondingly positioned ceramic slab.

In the prior art, there is a need for production which is as advantageous as possible in terms of technology and economy, allows a stable connection between the ceramic slab and the concrete body and also withstands the requirements arising from the later use of the composite body, in particular the weather conditions (humidity and temperature), in particular because of the increasing need for composite bodies composed of a ceramic slab and a concrete body.

The present invention is based on the object of achieving a method for producing a composite body which has a concrete body and a planar element, by means of which a solid and permanent connection between the concrete body and the planar element is created, and which is technically and economically advantageously implementable.

This object is achieved according to the invention by the features of claim 1.

The present invention is also based on the object of achieving a device for producing a composite body which has a concrete body and a planar element, by means of which a solid and permanent connection between the concrete body and the planar element can be established.

This object is achieved according to the invention by the features of claim 18.

The present invention is furthermore based on the object of providing a composite body of a concrete body and a planar element which is economically and technically advantageously produced and in which the concrete body is fixedly and permanently connected to the planar element.

A composite body of this type is provided by the features of claim 26.

The method according to the invention for producing a composite body which has a concrete body and a planar element provides that a lower side of the planar element is adhesively bonded to an upper side of the concrete body. The upper side of the planar element forms the upper side of the composite body.

According to the invention, it is provided that an adhesive is applied to at least a sub-region of the lower side of the planar element, and the planar element is subsequently moved to the concrete body and is pressed onto the upper side of the concrete body. The pressing of the planar element onto the concrete body is carried out in a green-stable state of the concrete body, in which the concrete body is dimensionally stable but not yet cured.

A green-stable concrete body is understood to mean in particular a concrete body in which the main compaction process has been completed, but which has not yet cured.

In the prior art, a concrete body in the green-stable state is also referred to as a “green” concrete blank. The green-stable state of the concrete body means that the concrete body is already sufficiently cured to retain its shape when the concrete body leaves the production mold or the casting mold or the filling mold, or when the concrete body would be removed from the mold.

The planar element provided with the adhesive is pressed onto the upper side of the concrete body when the latter is still moist.

It has proven to be suitable or sufficient if the adhesive is applied to at least a sub-region of the lower side of the planar element. Although it can be provided in principle that the adhesive is applied completely to the lower side of the planar element, this is not mandatory for producing a solid and permanent connection between the planar element and the concrete body and is not necessarily advantageous either, as will yet be explained in more detail hereunder.

It has furthermore proven advantageous in the context of the method according to the invention when the adhesive is applied only to the lower side of the planar element and not additionally to the upper side of the concrete body provided for adhesively bonding to the planar element. In contrast to the teaching according to EP 3 216 775 B1, it is considered advantageous in the present case when the adhesive is applied only on one side, i.e. when the adhesive is applied only to at least a sub-region of the lower side of the planar element.

The inventors have recognized that a particularly advantageous method for producing a composite body is obtained when, as opposed to the prior art, the planar element, the adhesive being applied to the lower side thereof, after the application of the adhesive is moved to the concrete body and pressed onto the upper side of the concrete body. This sequence has proven advantageous in comparison to moving the concrete body to the planar element, and can in particular also be more easily integrated into the production of the concrete block. Solid and permanently reliable adhesive bonding of the planar element to the concrete body can be achieved according to the invention in that the planar element is pressed onto a concrete body which is in a green-stable state, i.e. in a state in which the concrete body is dimensionally stable but has not yet, or not yet completely, cured. It has been demonstrated that this method can achieve a solid connection between the planar element and the concrete body, which is also permanently reliable in relation to weather conditions, in particular with regard to moisture and temperature fluctuations. The method according to the invention is not only suitable for connecting a concrete body to a tile body or a ceramic slab, but it has been demonstrated that the method is suitable for connecting a concrete body to any planar element which is preferably formed from a further material, or a material dissimilar from the concrete body.

In the context of the invention, a composite body is a body which, in addition to the concrete body, has at least one planar element which is preferably formed from a further material.

The composite body is preferably a composite stone which is formed from the concrete body and a planar element, in particular a slab.

According to the invention, it can be provided that the planar element is formed as a slab, in particular as a ceramic slab, rubber slab, vinyl slab, checker board, stainless steel slab or metal slab, in particular having a structured upper side and/or as a tile, as natural stone or as a laminate.

The method according to the invention is particularly suitable when the planar element is formed as a ceramic slab, in particular as a tile.

The composite bodies according to the invention preferably have vertically extending spacers which are formed by the concrete body, in a manner fundamentally known. Such spacers are known, for example, from EP 2 401 432 B1.

According to the invention, it can also be provided that a mineral adhesive is used as the adhesive.

It has been demonstrated that the use of a mineral adhesive allows a particularly strong and permanently reliable connection between the planar element and the concrete body to be achieved.

According to the invention, it can also be provided that the planar element is moved so as to be plane-parallel and/or orthogonal relative to the upper side of the concrete body during pressing onto the concrete body.

It has proven to be particularly advantageous when the planar element is moved so as to be plane-parallel and/or orthogonal (vertical) relative to the upper side of the concrete body during pressing onto the concrete body. Preferably, it is provided in the process that, for this purpose, the planar element is moved during pressing onto the concrete body. However, it is fundamentally also possible to move the concrete body or to move both elements while pressing the planar element onto the concrete body.

In the context of the method according to the invention, it has proven to be particularly advantageous when the concrete body is not moved while pressing the planar element, but the plane-parallel and/or orthogonal movement, preferably an oscillating and/or vibrating movement, is generated only by the planar element.

It has been demonstrated that by moving the planar element during pressing onto the concrete body, the adhesive can be activated in a particularly advantageous manner and a solid and reliable connection between the planar element and the concrete body can be established.

In contrast to the prior art, in which compaction and vibration is provided only after filling the concrete material into the casting mold in which the planar element is located, it has proven to be advantageous when the planar element is moved so as to be plane-parallel and/or orthogonal relative to the upper side of the concrete body while pressing the planar element onto the concrete body.

It is advantageous when the planar element is moved so as to vibrate and/or oscillate relative to the upper side of the concrete body during pressing.

It has been found to be particularly suitable when the planar element is moved so as to vibrate and/or oscillate relative to the upper side during pressing.

The vibration and/or the oscillation takes place at such an intensity that the green-stable concrete body or its shape is not destroyed.

It has proven to be particularly advantageous when the vibrating and/or oscillating movement has an amplitude of less than 3 mm.

A movement of the planar element relative to the upper side of the concrete body has proven to be particularly suitable for activating the adhesive and for producing a solid and permanent connection.

It has been demonstrated that by pressing the planar element onto the concrete body, the adhesive is distributed in a suitable manner and the adhesive is connected to the concrete body in a particularly advantageous manner by the vibration and/or the oscillation, in particular also penetrates into pores of the concrete body.

It has been demonstrated that a particularly advantageous composite body can be produced when the concrete body has a water/cement content (water cement value abbreviated: w/z value) of 0.25 to 0.45, i.e. a proportion of water between 25% and 45% of the proportion by weight of the cement, when the planar element is pressed onto the concrete body; in particular, a water/cement content of 0.35 to 0.45 has proven to be particularly suitable.

It has been demonstrated that a particularly advantageous composite body can be produced when the concrete body has a water/binder content (water binder value abbreviated: w/b value) of 0.25 to 0.45, i.e. a proportion of water between 25% and 45% of the proportion by weight of the binder, when the planar element is pressed onto the concrete body; in particular, a water/binder proportion of 0.35 to 0.45 has proven to be particularly suitable.

It has proven to be advantageous when the concrete body has 10% to 25% natural sand of 0 to 4 mm, preferably 14% to 22%, in particular 16% to 20% natural sand of 0 to 4 mm.

It has also proven to be particularly suitable when the adhesive is applied to, and/or sprayed onto, the lower side of the planar element.

It is advantageous when the adhesive is applied in portions to the lower side of the planar element, preferably while omitting an encircling periphery of the lower side of the planar element.

It can be provided within the scope of the method according to the invention that the adhesive is applied completely to the entire lower side of the planar element. However, it has proven to be advantageous when the adhesive is not applied completely, but preferably only in portions, or to a sub-region, of the lower side, preferably in portions over the entire lower side. It has proven to be particularly suitable when an encircling periphery of the lower side of the planar element is omitted, i.e. an adhesive is applied only to a sub-region of the lower side. It has proven to be advantageous when no adhesive is squeezed out over the periphery of the lower side of the planar element when pressing the planar element onto the concrete body. This can be advantageously achievable, for example, in that an encircling periphery of the lower side of the planar element is omitted when applying the adhesive.

The adhesive can preferably be applied on the lower side of the planar element in such a manner that the planar element, with the lower side oriented upward, is pushed through below an adhesive application apparatus, wherein the adhesive application apparatus applies the adhesive preferably with a toothed spatula structure over part of the area, preferably distributed over the entire lower side, particularly preferably while omitting an encircling periphery, on the lower side of the planar element.

Further advantageous measures by way of which it can be achieved that no adhesive escapes when pressing the planar element onto the concrete body are shown below in yet more detail, wherein these measures can also be used in combination with and/or as alternatives to omitting an encircling periphery.

It is advantageous when the adhesive is applied with a toothed spatula structure to the lower side of the planar element, wherein the adhesive is preferably applied in such a manner that the adhesive has a thickness of 3 mm to 10 mm, preferably 4 mm to 8 mm, in particular 5 mm to 7 mm, in those regions in which it has a greater thickness on the lower side of the planar element.

It has proven to be particularly advantageous when the adhesive is applied with a toothed spatula structure. It can be provided in the process that the toothed spatula structure is designed in such a manner that an adhesive is provided both in the heights (elevations) and in the depths of the structure resulting from the toothed spatula. However, it has proven to be particularly advantageous that no adhesive is provided in the trenches of the toothed spatula structure. By pressing the planar element onto the upper side of the concrete body, the adhesive is then preferably distributed completely on the lower side of the planar element, preferably while omitting an encircling periphery.

According to the invention, it can be provided that the upper side of the concrete body is structured, in particular roughened, and/or provided with grooves and/or with ribs and/or a toothed spatula structure, prior to pressing the planar element.

For the production of a solid and permanently reliable connection between the planar element and the concrete body, it has proven to be particularly suitable when the upper side of the concrete body is structured, in particular roughened, before pressing the planar element. In addition or alternatively, it can also be provided that grooves and/or ribs are inserted into the upper side of the concrete body and/or the upper side of the concrete body has a toothed spatula structure. The above-mentioned design embodiment of the upper side of the concrete body before pressing the planar element can be provided alternatively to, but also effected in conjunction with, the fact that the adhesive is applied with a toothed spatula structure to the lower side of the planar element.

It is advantageous when the upper side of the concrete body is structured by a punch pressed on the upper side of the concrete body in the production of the concrete body, preferably by a punch used for compacting the concrete body.

It has proven to be particularly suitable to achieve the structuring and/or the grooves and/or the ribs and/or the toothed spatula structure in the upper side of the concrete body in that the upper side of the concrete body is structured by a punch pressed on the upper side of the concrete body in the production of the concrete body. Preferably, the punch which is used in a fundamentally known manner for compacting the concrete body can be used for this purpose. Such a punch is typically pressed onto the concrete body for compacting the concrete body when the latter is still in the casting mold.

According to the invention, it can furthermore be provided that the peripheral region of the upper side of the concrete body, preferably so as to encircle the upper side of the concrete body, is provided with pockets and/or depressions and/or indentations and/or a chamfer, which are or is suitable to absorb adhesive that has been displaced by pressing the planar element.

It has proven to be particularly advantageous when the upper side of the concrete body has pockets and/or depressions and/or indentations and/or a chamfer which are or is suitable to absorb adhesive that has been displaced by pressing the planar element. The pockets, depressions, indentations or the chamfer can thus serve as a reservoir to absorb adhesive that is displaced when the planar element is pressed onto the concrete body.

It is advantageous when the pockets and/or the depressions and/or the indentations and/or the chamfer are or is incorporated by a punch pressed in the production of the concrete body on the upper side of the concrete body, preferably a punch, which is used for compacting the concrete body.

It has proven to be particularly suitable when the pockets and/or the depressions and/or the indentations and/or the chamfer are already incorporated into the concrete body during the production of the latter, in particular in that a punch is pressed onto the upper side of the concrete body. Preferably, as already described above with regard to the structuring, a punch can be used for this purpose, which is anyway used for compacting the concrete body at a time when the concrete body is still in the casting mold or a production mold, in particular a casting mold of a production mold, wherein the punch serves to compact the concrete body in a fundamentally known manner.

The casting molds of a production mold are also referred to as formwork molds.

According to the invention, it can be provided that the position of the concrete body is determined, preferably measured, before pressing the planar element.

Methods can be used for this purpose in a manner fundamentally known. The position can be determined in particular also with the aid of optical sensors. In contrast to the solution, which is known from the generic document and in which the tile is in a defined position within the casting mold, it is advantageous in terms of automated production of the composite body when the position of the concrete body is determined before pressing on the planar element, in order that a high production quality can be achieved.

It is advantageous when the position of an entire production layer of concrete bodies is measured, preferably in that two diagonally opposite corner points of the production layer are measured.

It has proven to be particularly efficient if the position of an entire production layer of concrete bodies is measured. The production layer is preferably defined by a production mold which is used in the production of the concrete bodies and is filled into the concrete mass for forming the concrete bodies. The production mold can optionally have only one casting mold which in this instance corresponds to the production mold, or, however, the production mold has a plurality of casting molds which in this instance preferably define a production layer of the concrete bodies.

Measuring a production layer can preferably be carried out in that two diagonally opposite corner points of the production layer are measured, or their position is determined. The position of all concrete bodies in the production layer can then be determined or derived from the position of said corner points. The position of the concrete bodies of a production layer relative to one other, after the concrete bodies have left the casting mold, is usually not arbitrary, but results from the casting mold, or can be derived from it. It has been demonstrated that it is sufficient when two diagonally opposite corner points of the production layer are measured or determined by corresponding sensors.

For measuring a single concrete body, but in particular for measuring the entire production layer, corresponding measuring instruments can be used within the context of the method according to the invention, in particular optical sensors which measure the entire layer at once, preferably in that opposite points or corner points of the production layer are measured. The position and the orientation of the production layer are preferably determined by ascertaining only two points.

According to the invention, it can furthermore be provided that the lower side of the planar element is cleaned of dust before applying the adhesive, in particular blown off and/or brushed off.

It has proven to be particularly suitable when the lower side of the planar element is cleaned of dust before applying the adhesive. Blowing-off or brushing-off has proven to be particularly suitable here. In particular tiles or ceramic slabs are usually sanded, so that dust is located on the tile or the ceramic slab. With the aid of a blower or a brushing tool, dust of this type can be particularly advantageously removed, whereby the adhesive bond between the planar element and the concrete body is improved.

According to the invention, it can furthermore be provided that the concrete body after adhesively bonding the planar element is fed to a curing area, preferably a curing chamber, which has a higher temperature and in which the concrete body cures.

It has proven to be particularly suitable when the concrete body after adhesively bonding the planar element, thus the composite body produced in this way, is fed to a curing area, preferably a curing chamber. In the curing area or the curing chamber, the concrete body can then accordingly cure. It has also been demonstrated that this also improves the connection between the planar element and the concrete body, or the hardening of the adhesive.

It is advantageous when the dimensions of the lower side of the planar element correspond substantially to the dimensions of the upper side of the concrete body, wherein preferably the extent of the upper side of the planar element in a longitudinal direction and a width direction is in each case 1 mm to 40 mm, preferably 2 mm to 30 mm, in particular 3 mm to 20 mm, particularly preferably 4 mm to 10 mm, less than an extent of the upper side of the concrete body in the respective direction.

The aforementioned dimensions have proven to be particularly suitable for producing a composite body. In particular, it has proven to be suitable when the extent of the planar element in a longitudinal direction and a width direction is less than an extent of the upper side of the concrete body in the respective direction.

It can be advantageous when the planar element is adhesively bonded to the concrete body while the concrete body is still in a production mold or a casting mold in which the concrete body is compacted, or the planar element is adhesively bonded to the concrete body after the concrete body has left a production mold or a casting mold in which the concrete body is compacted.

It has proven to be particularly advantageous when the planar element is only adhesively bonded to the concrete body when the concrete body has left the production mold or the casting mold in which the concrete body is compacted. In this case, this is a green-stable concrete body, or a freshly completed and already demolded concrete body, or concrete brick. The concrete body is therefore located outside the production mold or the casting mold. However, the concrete body has not yet cured, or is preferably not yet in the curing area or the curing chamber. In this state, the planar element can be applied in a particularly suitable manner, both technically and economically.

Alternatively, however, it is also possible that the planar element is adhesively bonded to the concrete body while the concrete body is still in the production mold or the casting mold in which the concrete body is compacted. The concrete body has already been compacted, so the concrete body is in a green-stable state, but still in the production mold or the casting mold. It can be particularly suitable for special applications that the planar element is adhesively bonded to the concrete body in this state of the latter. An advantage of applying the planar element to the concrete body while it is still in the production mold or the casting mold can lie in that the planar element can be placed precisely, since the position of the concrete body in the production mold or the casting mold is still precisely predefined. However, pressing and positioning the planar element requires more time than when the concrete body has already left the production mold or the casting mold.

It is advantageous when the planar element is adhesively bonded to the concrete body in a state in which it is already dimensionally stable, meaning after the completion of the main compaction process, but has not yet completely cured. Preferably, the concrete body here is no longer in the production mold or the casting mold in which it was compacted.

It is advantageous when the planar elements are fed in one operational step to the concrete body and pressed onto said concrete body, preferably using a multi-axis robot, in particular a six-axis robot.

An advantageous device according to the invention for producing a composite body is defined in claim 18.

The device according to the invention for producing a composite body which has a concrete body and a planar element, wherein a lower side of the planar element is adhesively bonded to an upper side of the concrete body and an upper side of the planar element forms an upper side of the composite body, has an adhesive application apparatus which applies an adhesive to at least a sub-region of the lower side of the planar element. The device according to the invention furthermore has a feeding apparatus which moves the planar element provided with the adhesive to the concrete body, and presses the lower side of the planar element onto the upper side of the concrete body. Furthermore provided according to the invention is a concrete body provisioning apparatus in which the concrete body is in a green-stable state in which the concrete body is dimensionally stable but not yet cured. It is provided according to the invention that the feeding apparatus is positioned relative to the concrete body provisioning apparatus in such a manner that the planar element is able to be pressed onto the green-stable concrete body.

The device according to the invention enables particularly advantageous production of a composite body which has a concrete body and a planar element. The adhesive application apparatus is specified to provide at least a sub-region of the lower side of the planar element with an adhesive, or to apply said adhesive there. A cycle time of 3 seconds to 10 seconds, preferably 4 seconds to 6 seconds, is preferably provided for applying the adhesive. Subsequently, the planar element is moved to the concrete body by the feeding apparatus, and the lower side of the planar element is pressed onto the upper side of the concrete body. The concrete body herein is located in a concrete body provisioning apparatus in which the concrete body is in a green-stable state.

The feeding apparatus and the concrete body provisioning apparatus are positioned in such a manner that the planar element can be pressed onto the green-stable concrete body, preferably in one operational step. The feeding apparatus can preferably comprise a multi-axis robot, preferably a six-axis robot.

The concrete body provisioning apparatus can obtain the concrete bodies, preferably a production layer of concrete bodies, from a concrete body production apparatus. The concrete bodies can still be in the production mold or a casting mold of the production mold, or have preferably already been removed from the production mold or a casting mold of the production mold. The production of the concrete bodies in the concrete body production plant can take place fundamentally in a known manner. The device according to the invention can thus also be combined in a particularly advantageous manner with already existing concrete body production apparatuses in which it is provided that a pourable concrete material is filled into a mold.

It is advantageous when an activation apparatus is provided, which moves the planar element relative to the upper side of the concrete body during pressing onto the concrete body, in order to activate the adhesive.

It has proven to be particularly suitable when the planar element is moved relative to the upper side of the concrete body during pressing onto the concrete body. In principle however, it is also possible that the concrete body onto which the planar element is pressed is moved during the pressing. It is also possible that the device is designed in such a manner that both the planar element and the concrete body are moved when pressing the planar element onto the concrete body.

The activation apparatus can preferably comprise a vibration apparatus and/or an oscillation apparatus, which cause the planar element to vibrate or oscillate relative, preferably substantially plane-parallel and/or orthogonal, to the upper side of the concrete body.

It is advantageous when a lower side of a punch, provided for compacting the concrete body, of a concrete body production apparatus is designed in such a manner that the punch structures, in particular roughens, the upper side of the concrete body, and/or the punch incorporates pockets and/or depressions and/or indentations and/or a chamfer into the peripheral region of the upper side of the concrete body.

It has been demonstrated that a design embodiment of the upper side of the concrete body in such a manner that it is structured, in particular roughened, leads to the planar element being able to be bonded particularly well to the concrete body. Furthermore, it has been demonstrated that it can also be advantageous when pockets and/or depressions and/or indentations and/or a chamfer are incorporated into the peripheral region of the upper side of the concrete body. The pockets, depressions, indentations or the chamfer can in particular serve as a reservoir to absorb material of the adhesive when it is displaced by the planar element being pressed. The pockets, depressions, indentations and/or the chamfer are preferably designed in such a manner that the adhesive is not squeezed out beyond the upper side of the concrete body.

Both the structuring and the pockets, the depressions, the indentations or the chamfer can preferably be inserted with a punch which is pressed onto the upper side of the concrete body before the concrete body is completely cured. It is advantageous when the punch of a concrete body production apparatus is used, which is present anyway to compact the concrete body during production in the production mold.

According to the invention, it can be provided that a cleaning apparatus is provided for cleaning the lower side of the planar element before applying the adhesive and/or the upper side of the concrete body before pressing the planar element, in particular for blowing off or brushing off dust.

It has proven to be particularly suitable when a cleaning apparatus is provided, which is designed in such a manner that the lower side of the planar element can be cleaned before applying the adhesive, in particular to blow or brush dust off said lower side. For this purpose, the cleaning apparatus can be designed as a blower or as a brushing tool, for example as a rotating brush, or comprise a blower or a brushing tool. Alternatively or additionally, the cleaning apparatus can also be designed in such a manner that the upper side of the concrete body can be cleaned before pressing the planar element, in particular to blow or brush dust off said upper side. For this purpose, the cleaning apparatus can again be designed as a blower or as a brushing tool, for example as a rotating brush, or have a blower or a brushing tool.

The cleaning apparatus can in particular also be formed in two parts, or have two or more cleaning modules to clean both the lower side of the planar element and the upper side of the concrete body.

According to the invention, a measuring apparatus can also be provided to determine, in particular measure, the position of the concrete body on the concrete body provisioning apparatus.

It has proven to be advantageous when the device according to the invention comprises a measuring apparatus which, with the aid of sensors, preferably optical sensors, determines or measures the position of the concrete body onto which the planar element is pressed. It can also be provided that the measuring apparatus is designed to determine, in particular measure, the position of an entire production layer of concrete bodies. For this purpose, it can be sufficient if the measuring apparatus determines or measures the position of two defined points of the production layer, for example two diagonally opposite corners, so that, supported by a computing device, the position of the individual concrete bodies of the production layer can be determined or calculated accordingly. This is possible because the position of the individual concrete bodies of a production layer relative to one another is typically known, or determined by the production mold.

According to the invention, a curing area, in particular a curing chamber, can be provided, which has a higher temperature and into which the composite body can be moved after the planar element is adhesively bonded to the concrete body.

It has proven to be advantageous when the concrete body or the composite body is not moved into a curing area, in particular a curing chamber, or a drying chamber, in which a higher temperature prevails, in particular a higher temperature than in the concrete body provision apparatus, until after the planar element is applied or adhesively bonded to the concrete body, so that the green-stable concrete body or the green concrete body can cure. Such curing chambers or drying chambers are fundamentally known from the prior art.

It is advantageous when the planar element is a slab, in particular a ceramic slab, a rubber slab, a vinyl slab, a checker board, a stainless steel slab or a metal slab, in particular having a structured upper side, and/or the planar element is a tile, a natural stone or a laminate.

It has been demonstrated that any slabs, in particular ceramic slabs or tiles, can be connected to a concrete body in a particularly advantageous manner by means of the device according to the invention. However, the device according to the invention is also particularly suitable for connecting a planar element, which is a rubber slab, a vinyl slab, a checker board, a stainless steel slab or a metal slab, in particular having a structured upper side, a natural stone or a laminate, to a concrete body.

It has proven to be particularly suitable when the adhesive is a mineral adhesive.

It has been demonstrated that a planar element can be particularly advantageously connected to a green-stable concrete body by means of a mineral adhesive.

It has been demonstrated that when the planar element is adhesively bonded to the concrete body in a green-stable state, i.e. in a state in which the concrete body is still “wet”, less adhesive is required. In this case, it can be already sufficient if the adhesive has a thickness or height or vertical measurement of 1 mm.

It has also been demonstrated that the prior cleaning of the concrete body and/or the planar element of dust significantly improves the adhesive bond and in particular leads to the fact that less adhesive is required.

It has also been demonstrated that talc on the planar element, especially if the latter is a ceramic, is disadvantageous when adhesively bonding on the lower side of the planar element. It can therefore be advantageous to remove talc before applying the adhesive to the lower side of the planar element preferably by a mechanical action, in particular tapping, striking or brushing. Here, the use of a device for aging concrete blocks, as is known in particular from EP 1 893 391 B1, can be advantageous. The impactors can act on the lower side of the planar element. Instead of the paving stones to be aged, the planar elements, in particular ceramic slabs, to be freed from talc can be transported below the impactors. The device according to EP 1 893 391 B1 can be operated as described for the aging of the paving stones.

It has further proven to be advantageous when the two faces to be bonded to one other have a rough surface. The upper side of the concrete body has already proven fundamentally to be suitable for this purpose. In order to achieve a roughness also at the lower side of the planar element, it can in turn be advantageous when the lower side of the planar element was treated or roughened with a method or a device according to EP 1 893 391 B1 before the application of the adhesive.

It is advantageous when the concrete body has lateral spacers which are formed on the side walls of the concrete body and extend at least over part of the height of the side walls from the direction of the lower side of the concrete body toward the upper side of the concrete body. The spacers preferably extend in a direction orthogonal to the lower side or upper side of the concrete body.

It can be sufficient when the spacers are designed in the manner of a bead and have a width or thickness of 1 mm to 5 mm, preferably 1 mm to 2 mm.

The chamfer, which is incorporated on the periphery of the concrete body into the upper side of the concrete body, can preferably have a width (extent plane-parallel to the upper side) of 2 mm to 8 mm and a depth (extent orthogonal to the upper side) of 2 mm to 8 mm, particularly preferably a width of 5 mm and a depth of 5 mm.

It has been demonstrated that the adhesive bond between the concrete body and the planar element becomes particularly positive when the planar element is pressed onto the upper side of the concrete body using a slight vibration.

The present invention also relates to a composite body having a concrete body and a planar element, wherein the composite body is produced according to a method as claimed in one of claims 1 to 17 and/or by a device as claimed in one of claims 18 to 25.

Features which have been described in connection with one of the subjects of the invention, specifically provided by the method according to the invention or the device according to the invention, are also advantageously implementable for the other subject of the invention. Likewise, advantages specified in connection with one of the subjects of the invention can also be understood in relation to the other subject of the invention.

In addition, it should be noted that expressions such as “comprising”, “having” or “with” do not exclude any other features or steps. Furthermore, terms such as “a” or “the” that refer in singular to steps or features do not exclude a plurality of features or steps-and vice versa.

It should be noted that labels such as “first” or “second”, etc. are used predominantly for reasons of being able to distinguish between respective device or method features and are not necessarily intended to indicate that features require one another or are related to one another.

The invention will be described in more detail hereunder by means of the drawing and an exemplary embodiment.

The figures each show preferred exemplary embodiments in which individual features of the present invention are illustrated in combination with one another. Features of one exemplary embodiment can also be implemented separately from the other features of the same exemplary embodiment.

Elements of equivalent function are denoted by the same reference signs in the figures.

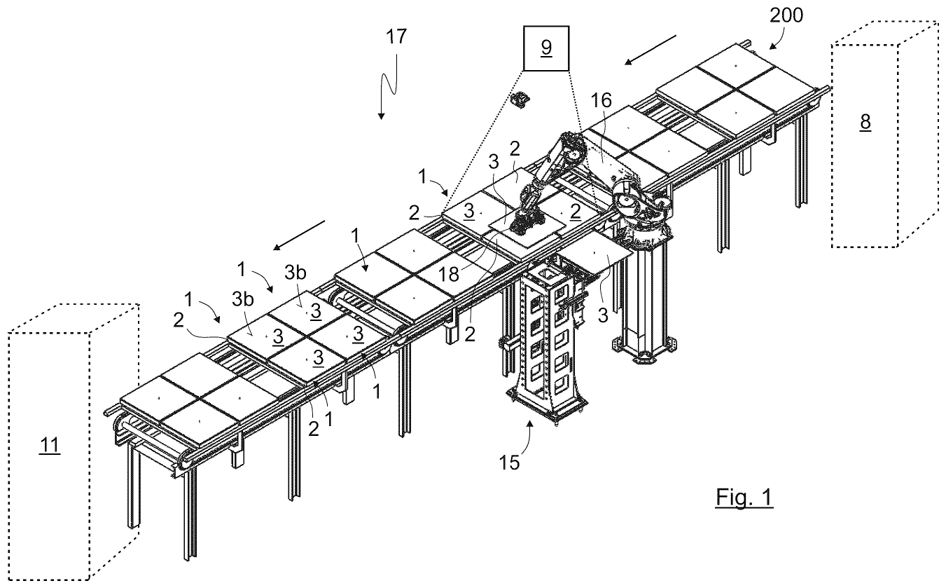

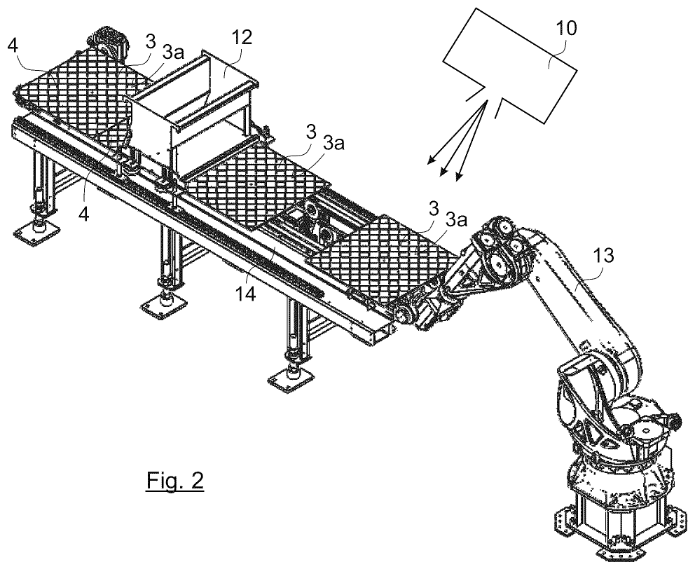

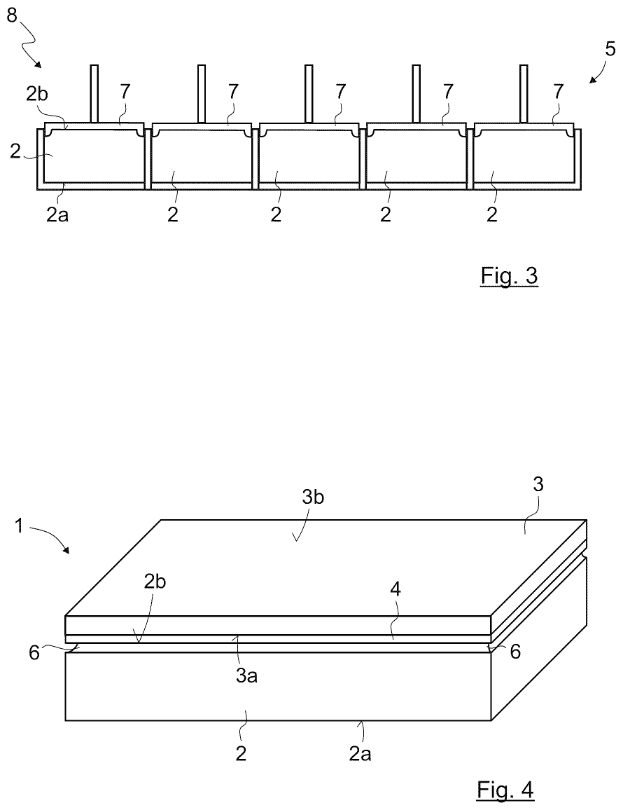

In the figures:
FIG. 1 shows a schematic illustration of part of a device according to the invention, or of a method according to the invention, to press a planar element onto a green-state concrete body;
FIG. 2 shows a schematic illustration of part of a device according to the invention, and of a method according to the invention, to apply an adhesive to a lower side of a planar element and to place a planar element on a conveyor belt and to feed the planar element to an adhesive application apparatus;
FIG. 3 shows a schematic cross section of a production mold with an exemplary illustration of five casting molds in which a concrete body is or has been formed in each case, and with an illustration of punches pressing from above onto the concrete body in order to compact it and, if necessary, structure it or chamfer it; and
FIG. 4 shows a schematic illustration of a composite body which comprises a concrete body and a planar element, wherein a lower side of the planar element is adhesively bonded to an upper side of the concrete body, and an upper side of the planar element forms an upper side of the composite body.

The following exemplary embodiment is used for the disclosure of an advantageous method for producing a composite body and for the disclosure of an advantageous device for producing a composite body. A composite body 1 produced according to the method or by means of the device is schematically illustrated in FIG. 4.

The composite body 1 has a concrete body 2 and a planar element 3.

The concrete body 2 has a lower side 2a and an upper side 2b.

The planar element 3 has a lower side 3a and an upper side 3b.

The lower side 3a of the planar element 3 is adhesively bonded to the upper side 2b of the concrete body 2.

As illustrated in FIG. 4, the upper side 3b of the planar element 3 forms an upper side of the composite body 1.

In the exemplary embodiment it is provided that an adhesive 4 is applied to at least a sub-region of the lower side 3a of the planar element 3. The adhesive 4 is illustrated (enlarged) in the schematic illustration in FIG. 4. The application of the adhesive 4 to the planar element 3 is shown in FIG. 2.

In the exemplary embodiment, it is provided that the adhesive 4 is a mineral adhesive.

In a manner not illustrated in more detail, it is provided in the exemplary embodiment that the adhesive 4, preferably while omitting an encircling periphery, is applied to the lower side 3a of the planar element 3 in portions, optionally even completely.

In a manner likewise not illustrated in more detail, it is also provided that the adhesive 4 is applied with a toothed spatula structure to the lower side 3a of the planar element 3, wherein the adhesive 4 is preferably applied in such a manner that the adhesive 4 in those regions in which the latter has a greater thickness on the lower side 3a of the planar element 3 has a thickness of 3 mm to 10 mm, preferably 4 mm to 8 mm, in particular 5 mm to 7 mm.

Furthermore, it can be provided in the exemplary embodiment that the upper side 2b of the concrete body 2 is structured, in particular roughened, and/or provided with grooves and/or with ribs and/or with a toothed spatula structure, before pressing the planar element 3. In the exemplary embodiment, potential structuring of the upper side 2b of the concrete body 2 is not illustrated in more detail. Structuring the upper side 2b of the concrete body 2 can be achieved particularly advantageously by a punch 7 described in more detail below and illustrated by way of example in FIG. 3. In the exemplary embodiment, it can furthermore be provided that the peripheral region of the upper side 2b of the concrete body 2, preferably encircling the upper side 2b of the concrete body 2, is provided with pockets and/or depressions and/or indentations and/or a chamfer 6, which are or is suitable to absorb adhesive 4 that has been displaced by pressing the planar element 3. In the exemplary embodiment, a circumferential chamfer 6 is shown by way of example in FIG. 4, which can serve as a reservoir for absorbing a displaced adhesive 4.

In the exemplary embodiment, it can be provided that a lower side of a punch 7 is designed in such a manner that the punch 7 provides the upper side 2b of the concrete body 2 with a chamfer 6, or incorporates a chamfer 6 into the upper side 2b of the concrete body 2. The punch 7 can alternatively or additionally also be designed in such a manner that it structures, in particular roughens, the upper side 2b of the concrete body 2, and/or incorporates pockets and/or depressions and/or indentations into the peripheral region of the upper side 2b of the concrete body 2.

The punch 7 can preferably be a punch 7 which is used for compacting the concrete body in a concrete body production apparatus 8.

A punch 7 of a concrete body manufacturing apparatus 8 is shown by way of example in FIG. 3. FIG. 3 shows that the punch 7 compacts the concrete body 2 or a concrete material located in a production mold 5. The number of casting molds that the production mold has can be arbitrary. The production mold 5 can also have only one casting mold. The production mold 5 is of a preferably rectangular, in particular square, construction and preferably has both in the longitudinal direction and in the width direction a plurality of casting molds, e.g. an arrangement of 2×2, 2×3, 2×4, 2×5, 3×3, 3×4, 3×5, 4×4, 4×5, 5×5 casting molds.

The basic construction of a concrete body production apparatus 8 is sufficiently known. Illustrated in FIG. 3 is only a fragment of the concrete body production apparatus 8, which shows the production mold 5 with the individual casting molds and the punches 7. The concrete body production apparatus 8 is also shown in dashed lines and by way of example in FIG. 1.

In the production of the concrete bodies or a concrete block, fresh concrete from cement, rock granules and water is generally poured into the individual casting molds of the production mold. The casting molds or the production mold usually consist of metal or plastics material. In the casting molds, the freshly cast concrete solidifies and is compacted with the aid of one of the punches 7. Subsequently, the dimensionally stable, but not yet cured concrete body from the casting mold is demolded and fed to the concrete body provisioning apparatus 17 (see FIG. 1) shown in more detail below.

In the exemplary embodiment, it is provided that the position of the concrete body 2 is determined, preferably measured, before pressing the planar element 3. In the exemplary embodiment, it is preferably provided for this purpose that the position of an entire production layer 200 of concrete bodies 2 is measured, preferably in that two diagonally opposite corner points of the production layer 200 are measured.

FIG. 1 illustrates by way of example a plurality of production layers 200 of concrete bodies 2. Each production layer 200 is illustrated by way of example by four concrete bodies 2, which are positioned in a 2×2 arrangement.

For measuring purposes, a measuring apparatus 9 is shown in FIG. 1 by way of example in order to determine, in particular measure, the position of the concrete body 2 or a production layer 200. The measuring apparatus 9 is preferably an optical measuring apparatus. It is illustrated by dashed lines in FIG. 1 that the measuring apparatus 9 measures two diagonally opposite corners of the production layer 200.

In the exemplary embodiment, it is preferably provided that the lower side 3a of the planar element 3 is cleaned of dust before applying the adhesive 4. By way of example, a cleaning apparatus 10 is shown in FIG. 2, which can be designed in such a manner that it cleans the lower side 3a of the planar element 3 before applying the adhesive 4. The cleaning apparatus 10 is designed as a blower in the exemplary embodiment. The cleaning apparatus 10 can alternatively also be designed as a brushing tool.

Alternatively or additionally, the cleaning apparatus 10 can also be provided to clean, in particular to blow off or brush off dust from, the upper side 2b of the concrete body 2 before pressing the planar element 3. The cleaning apparatus 10 can optionally have two or a plurality of, preferably independently operable cleaning modules for this purpose.

In the exemplary embodiment, it is provided that after adhesively bonding the planar element 3, the concrete body 2, i.e. the composite body 1 created as a result, is fed to a curing area, preferably a curing chamber 11. In the curing chamber 11 a higher temperature prevails, so that the concrete body 2 can cure or set. The curing chamber 11 also facilitates the curing of the adhesive 4. A curing chamber 11 is illustrated in dashed lines and by way of example in FIG. 1.

In the exemplary embodiment, it is preferably provided that the dimensions of the lower side 3a of the planar element 3 correspond substantially to the dimensions of the upper side 2b of the concrete body 2. The planar element 3 can preferably have a size of at least 10 cm×10 cm and preferably of at most 120 cm×120 cm, wherein the planar element 3 in the plan view does not have to be square, but can also have rectangular shapes or other polygonal shapes; round or oval shapes are optionally possible too.

The shape of the concrete body 2 and of the composite body formed by the adhesive bonding is designed accordingly. The extent of the lower side 3a of the planar element 3 in a longitudinal direction and a width direction is preferably in each case 1 mm to 40 mm, preferably 2 mm to 30 mm, in particular 3 mm to 20 mm, particularly preferably 4 mm to 10 mm smaller than an extent of the upper side 2b of the concrete body 2 in the respective direction.

In the exemplary embodiment, a particularly preferred method for adhesively bonding the planar element 3 to the concrete body 2 is shown in FIG. 1. It is provided that the planar element 3, after the concrete body 2 has left the production mold 5 in which the concrete body 2 is compacted, is adhesively bonded to the concrete body 2.

Alternatively, in a manner not shown in detail, it can also be provided that the planar element 3 is adhesively bonded to the concrete body 2, while the concrete body 2 is still in the production mold 5, which is illustrated by way of example in FIG. 3. The adhesive bonding of the planar element 3 to a concrete body 2, which is still in the production mold 5, is carried out in a state of the concrete body 2 in which the latter is green-stable. In principle however, it would also be possible, for special design embodiments, that the planar element 3 is pressed, in particular while vibrating, onto a concrete material which is located in the production mold 5, before a green-stable concrete body 2 is formed from the concrete material.

The planar element 3 shown in the exemplary embodiment is preferably a slab, in particular a ceramic slab or a tile. However, the planar element 3 can also be another slab, for example also a rubber slab, a vinyl slab, a checker board, a stainless steel slab or a metal slab, in particular having a structured upper side. The planar element 3 can alternatively also be formed as natural stone or as a laminate.

As derived from FIG. 2, an adhesive application apparatus 12 is provided in the exemplary embodiment, which is specified to apply an adhesive 4 to at least a sub-region of the lower side 3a of the planar element 3. It is illustrated by way of example in FIG. 2 that the planar element 3 is placed on a support surface, preferably a conveyor belt 14, with the aid of a first multi-axis robot 13, preferably a six-axis robot. In the process, the planar element 3 is placed in such a manner that the lower side 3a of the planar element 3 is oriented upward. With the aid of the cleaning apparatus 10, the lower side 3a of the planar element 3 can be blown off. The conveyor belt 14 in the exemplary embodiment according to FIG. 2 is specified in such a manner that it transports the placed planar elements 3 below the adhesive application apparatus 12. During transport, the adhesive 4 is preferably applied by the adhesive application apparatus 12 with a toothed spatula structure, preferably as described above.

Once the adhesive 4 has been applied to the lower side 3a of the planar element 3, the planar element 3 is picked up from the conveyor belt 14 with the aid of a lifting-and-turning apparatus 15, and is turned over in such a manner that the lower side 3a of the planar element 3 is oriented upward. A lifting-and-turning apparatus 15 is illustrated by way of example in FIG. 1.

In a manner not referred to in more detail, it can be provided that the lifting-and-turning apparatus 15 has a gripping unit, or a gripper, respectively, in order to pick up the planar element 3. Furthermore provided can be a lifting apparatus for lifting the planar element 3, and a rotating unit for rotating the gripping unit by 180° so that the lower side 3a, originally oriented upward on the conveyor belt 14, of the planar element 3 is oriented downward.

It should be mentioned that the application of the adhesive 4 can also be carried out with a differently designed adhesive application apparatus 12, for example by spraying or spreading, in particular in any orientation of the planar element 3.

In the exemplary embodiment, in place of a conveyor belt 14, another transport apparatus can further also be provided. Furthermore, the lifting-and-turning apparatus 15 can also be replaced by another apparatus, for example also by a multi-axis robot.

In the exemplary embodiment, it is provided in FIG. 1 that a feeding apparatus 16 picks up the planar element 3 provided with the adhesive 4, after the adhesive 4 has been applied to the lower side 3a of the planar element 3. In the exemplary embodiment, this takes place after the lifting-and-turning apparatus 15 has lifted and turned the planar element 3. Alternatively however, picking-up can also take place directly after the adhesive application apparatus 12, or directly from the conveyor belt 14 or any other transport apparatus.

The feeding apparatus 16 is designed in the exemplary embodiment as a second multi-axis robot. It should be noted that the use of the term “second multi-axis robot” does not mean that a first multi-axis robot must be provided. In the exemplary embodiment, the second multi-axis robot is preferably designed as a six-axis robot.

The feeding apparatus 16 moves the planar element 3 to the concrete body 2 and presses the lower side 3a of the planar element 3 onto the upper side 2b of the concrete body 2. In the process, the concrete body 2 is located on a concrete body provisioning apparatus 17, as illustrated in FIG. 1. The concrete body provisioning apparatus 17 is designed in the exemplary embodiment as a transport apparatus, for example as a conveyor belt or conveyor table. The concrete bodies 2 are transported on the concrete body provisioning apparatus 17 from a concrete body production apparatus 8 in the direction of the curing chamber 11 (see direction of arrow in FIG. 1). The concrete body production apparatus 8 and the curing chamber 11 are shown in this case only by way of example and with dashed lines and can be positioned in particular so as to be significantly spaced apart from one another in spatial terms.

Located in the concrete body provisioning apparatus 17 are concrete bodies 2 which display a green-stable state, i.e. are dimensionally stable, but are not yet cured. The feeding apparatus 16 is positioned relative to the concrete body provisioning apparatus 17 in such a manner that the planar element 3 is picked up by the lifting-and-turning apparatus 15, or optionally also immediately after the application of the adhesive 4, and can be pressed onto the green-stable concrete body 2 by means of the feeding apparatus 16 in one operational step.

In the exemplary embodiment, an activation apparatus 18 is provided, which moves, preferably vibrates and/or oscillates, the planar element 3 relative to the upper side of the concrete body 2 during pressing onto the concrete body 2, in order to activate the adhesive 4. In the exemplary embodiment, the activation apparatus 18 is preferably formed as part of the feeding apparatus 16, for example as the head of the multi-axis robot. The movement of the planar element 3 during the pressing onto the concrete body 2 can also be generated directly by the mobility inherent to a multi-axis robot.

The activation apparatus 18 can preferably be designed as a vibration and/or oscillation unit.

Once the adhesive 4 has been applied to the lower side 3a of the planar element 3, the planar element 3 is moved to the concrete body 2 and pressed onto the upper side 2b of the concrete body 2.

The pressing of the planar element 3 onto the concrete body 2 is schematically illustrated in FIG. 1. The concrete body 2 is in a green-stable state when the planar element 3 is pressed thereon, i.e., pressing the planar element 3 onto the concrete body 2 is carried out in a green-stable state of the concrete body 2, in which the concrete body 2 is dimensionally stable, but not yet cured.

It is illustrated in the exemplary embodiment herein that the concrete body 2 has already left the production mold 5 schematically illustrated in FIG. 3. In principle, however, it is also possible that the planar element 3 is pressed onto the concrete body 2 while the latter-in a green-stable state-is still located in the production mold 5.

It is provided in the exemplary embodiment that the planar element 3, while being pressed onto the concrete body 2, is moved plane-parallel and/or orthogonally (vertically) relative to the upper side 2b of the concrete body 2. This is preferably achieved in that the planar element 3 during pressing is moved so as to vibrate and/or oscillate relative to the upper side 2b of the concrete body 2.

What is claimed is:

1. A method for producing a composite body which comprises a concrete body and a planar element, whereupon a lower side of the planar element is adhesively bonded to an upper side of the concrete body, and wherein an upper side of the planar element forms an upper side of the composite body,
wherein an adhesive is applied to at least a sub-region of the lower side of the planar element, and the planar element is subsequently moved to the concrete body and is pressed onto the upper side of the concrete body, and wherein pressing the planar element (3) onto the concrete body is carried out in a green-stable state of the concrete body, in which the concrete body is dimensionally stable, but not yet cured.

2. The method as claimed in claim 1, wherein the planar element is moved plane-parallel and/or orthogonal relative to the upper side of the concrete body during pressing onto the concrete body.

3. The method as claimed in claim 1, wherein the planar element is moved so as to vibrate and/or oscillate relative to the surface of the concrete body during pressing.

4. The method as claimed in claim 1, wherein the adhesive is applied in portions to the lower side of the planar element, preferably while omitting an encircling periphery of the lower side (3a) of the planar element.

5. The method as claimed in claim 1, wherein the adhesive is applied with a toothed spatula structure to the lower side of the planar element, wherein the adhesive is applied in such a manner that the adhesive has a thickness of 3 mm to 10 mm in those regions in which it has a greater thickness on the lower side of the planar element.

6. The method as claimed in claim 1, wherein the upper side of the concrete body is structured, in particular roughened, and/or provided with grooves and/or with ribs and/or a toothed spatula structure, prior to pressing the planar element .

7. The method as claimed in claim 6, wherein the upper side of the concrete body is structured by a punch pressed on the upper side of the concrete body in the production of the concrete body, preferably a punch used for compacting the concrete body (2).

8. The method as claimed in claim 1, wherein the peripheral region of the upper side of the concrete body, preferably so as to encircle the upper side of the concrete body (2), is provided with pockets and/or depressions and/or indentations and/or a chamfer, which are or is suitable to absorb adhesive that has been displaced by pressing the planar element .

9. The method as claimed in claim 8, wherein the pockets and/or the depressions and/or the indentations and/or the chamfer are or is incorporated by a punch pressed in the production of the concrete body on the upper side of the concrete body, preferably a punch, which is used for compacting the concrete body.

10. The method as claimed in claim 1, wherein the position of the concrete body is determined, preferably measured, before pressing the planar element.

11. The method as claimed in claim 1, wherein the position of an entire production layer of concrete bodies is measured, preferably in that two diagonally opposite corner points of the production layer are measured.

12. The method as claimed in one of claim 1, wherein the lower side of the planar element is cleaned of dust before applying the adhesive, in particular blown off and/or brushed off.

13. The method as claimed in claim 1, wherein after adhesively bonding the planar element, the concrete body is fed to a curing area, preferably a curing chamber, which has a higher temperature and in which the concrete body cures.

14. The method as claimed in claim 1 , wherein the dimensions of the lower side of the planar element correspond substantially to the dimensions of the upper side of the concrete body, wherein preferably the extent of the lower side of the planar element in a longitudinal direction and a width direction is in each case 1 mm to 40 mm, smaller than an extent of the upper side of the concrete body in the respective direction.

15. The method as claimed in one of claim 1, wherein the planar element is adhesively bonded to the concrete body while the concrete body is still in a production mold in which the concrete body is compacted, or the planar element is adhesively bonded to the concrete body once the concrete body has left a production mold in which the concrete body is compacted.

16. The method as claimed in claim 1, wherein the planar element is formed as a slab, in particular as a ceramic slab, rubber slab, vinyl slab, checker board, stainless steel slab or metal slab, in particular with a structured upper side, and/or as a tile, as a natural stone or as a laminate.

17. The method as claimed in claim 1, wherein a mineral adhesive is used as adhesive.

18. A device for producing a composite body which has a concrete body and a planar element, wherein a lower side of the planar element is adhesively bonded to an upper side of the concrete body, and an upper side of the planar element forms an upper side of the composite body,
an adhesive application apparatus which applies an adhesive to at least a sub-region of the lower side of the planar element, and
a feeding apparatus which moves the planar element provided with the adhesive to the concrete body, and presses the lower side of the planar element onto the upper side of the concrete body, and
wherein a concrete body provisioning apparatus is provided, in which the concrete body is in a green-stable state in which the concrete body is dimensionally stable, but not yet cured, and wherein the feeding apparatus is positioned relative to the concrete body provisioning apparatus in such a manner that the planar element can be pressed onto the green-stable concrete body.

19. The device as claimed in claim 18, wherein an activation apparatus is provided, which moves the planar element relative to the upper side of the concrete body while being pressed onto the concrete body, in order to activate the adhesive.

20. The device as claimed in claim 18, wherein a lower side of a punch, provided for compacting the concrete body, of a concrete body production apparatus is designed in such a manner that the punch structures, in particular roughens, the upper side of the concrete body (2), and/or the punch incorporates pockets and/or depressions and/or indentations and/or a chamfer into the peripheral region of the upper side of the concrete body.

21. The device as claimed in one of claim 18, wherein a cleaning apparatus is provided in order to clean the lower side of the planar element before applying the adhesive, and/or the upper side of the concrete body before pressing the planar element, in particular in order to blow off or brush off dust.

22. The device as claimed in claim 18, wherein a measuring apparatus is provided to determine, in particular to measure, the position of the concrete body on the concrete body provisioning apparatus.

23. The device as claimed in claim 18, wherein a curing area, in particular a curing chamber, which has a higher temperature and into which the composite body is able to be moved after adhesively bonding the planar element to the concrete body , is provided.

24. The device as claimed in claim 18, wherein the planar element is a slab, in particular a ceramic slab, a rubber slab, a vinyl slab, a checker board, a stainless steel slab or a metal slab, in particular with a structured upper side, and/or the planar element is a tile, a natural stone or a laminate.

25. The device as claimed in claim 18, wherein the adhesive is a mineral adhesive.

26. A composite body, comprising a concrete body and a planar element, wherein the composite body is produced according to a method as claimed in one of claim 1.
